(19) United States
(12) Patent Application Publication
(10) Pub. No.: US 2006/0072774 A1
(43) Pub. Date: Apr. 6, 2006

(54) Electronic battery-powered hearing instrument, and method for operating such a hearing instrument

(75) Inventor: Martin Fluit, Mannedorf (CH)

Correspondence Address: PEARNE & GORDON LLP, 1801 EAST 9TH STREET, SUITE 1200, CLEVELAND, OH, 44114-3108, US

(73) Assignee: Phonak AG, Stafa (CH)

(21) Appl. No.: 10/957,353

(22) Filed: Oct. 1, 2004

(51) Int. Cl. H04R 25/00

(52) U.S. Cl. 381/312

(57) ABSTRACT

An electronic battery-powered hearing instrument comprises a first power supply terminal and a second power supply terminal arranged to contact a battery, a rectifier circuit for providing a positive supply voltage (Up) and a negative supply voltage (Un) regardless of a polarity of the battery relative to the first and second power supply terminal,
primary function means arranged to provide at least one drive signal (Ud) to a drive circuit for driving an electroacoustic conversion means by controlling electrical valve means (14, 15, 16, 17).

The drive circuit is electrically connected to the first power supply terminal and to the second power supply terminal, and the electrical valve means (14, 15, 16, 17) are polarity-independent, that is, they are able to operate regardless of the polarity of the voltage applied to their terminals.

As a result, the current path from the battery to the electroacoustic conversion means and back again comprises at the most two electrical valve means (14, 15, 16, 17), e.g. transistors, minimizing voltage drop and power loss.

### FIELD OF THE INVENTION

The invention relates to an electronic battery-powered hearing instrument, and to a method for operating such a hearing instrument, as described in the preamble of the corresponding independent claims.

### BACKGROUND OF THE INVENTION

The term “hearing instrument” or “hearing device”, as understood here, denotes on the one hand hearing aid devices that are-therapeutic devices improving the hearing ability of individuals, primarily according to diagnostic results. Such hearing aid devices may be Outside-The-Ear hearing aid devices or In-The-Ear hearing aid devices. On the other hand, the term stands for devices which may improve the hearing of individuals with normal hearing e.g. in specific acoustical situations such as in a very noisy environment or in concert halls, or which may even be used in context with remote communication or with audio listening for instance as provided by headphones.

The hearing devices as addressed by the present invention are so-called active hearing devices which comprise at the input side at least one acoustical to electrical converter, such as a microphone, at the output side at least one electrical to mechanical or electroacoustic converter, such as a loudspeaker, and which further comprise a signal processing unit for processing signals according to the output signals of the acoustical to electrical converter and for generating output signals to the electrical input of the electrical to mechanical output converter. In general, the signal processing circuit maybe an analog, digital or hybrid analog-digital circuit, and may be implemented with discrete electronic components, integrated circuits, or a combination of both.

Many battery-powered hearing instruments or hearing devices provide access to the battery in order to allow replacement by a user. It may then happen that small batteries, especially disc-type batteries used in e.g. watches and in particular in hearing aids, are inserted the wrong way around mechanically. As a result, their electrical polarity with respect to the device's normal operating condition is inverted, that is, the positive terminal of the battery is connected to the negative power terminal of the device, and the negative terminal of the battery is connected to the positive power terminal of the device. Consequently, the device will not operate and may even be damaged.

In order to overcome this problem, U.S. Pat. No. 5,661,420 proposes a rectifier circuit that accepts, at a pair of input terminals, a power supply whose polarity may be oriented either way, and provides, at a pair of output terminals, a voltage with a predefined polarity. In order to reduce losses—as compared to a diode rectifier bridge—the rectifier circuit comprises two transistor bridge circuits, with e.g. MOSFET transistors. The transistor switches are opened or closed in order to connect the input and output terminals according to the polarity at the input terminals. FIG. 1 shows this circuit as used in a hearing instrument according to this prior art. A battery 3 powers the rectifier circuit 6 which in turn powers an amplifier 8 with proper polarity, regardless of the orientation of the battery 3. The amplifier 8 accepts input signals from a microphone 9 and drives a speaker 13.

When powering the hearing instrument by means of such a rectifier, all the electronic circuits are powered by the rectifier. These circuits include primary function means which implement the essential signal processing of the hearing instrument, and a loudspeaker with an associated amplifier.

### DESCRIPTION OF THE INVENTION

It is an object of the invention to create an electronic battery-powered hearing instrument of the type mentioned initially, and a method for operating such a hearing instrument that reduces circuit losses, noise and power consumption.

The electronic battery-powered hearing instrument according to the invention comprises
a first power supply terminal and a second power supply terminal arranged to contact a battery,
a rectifier circuit for providing a positive supply voltage and a negative supply voltage regardless of a polarity of the battery relative to the first and second power supply terminal,
said primary function means arranged to provide at least one drive signal to a drive circuit for driving electroacoustic conversion means by controlling electrical valve means.

The drive circuit is electrically connected to the first power supply terminal and to the second power supply terminal, and the electrical valve means or switching means are polarity-independent, that is, they are able to operate regardless of the polarity of the voltage applied to their terminals.

As a result, the current path from the battery to the electroacoustic conversion means and back again preferably comprises at most two electrical valve means. This in turn reduces a voltage drop over the valve means and corresponding power losses. Furthermore, the low impedance of the connection from the supply to the power amplifier output reduces the signal to noise ratio and distortion of the amplified signal.

The polarity independent valve means preferably comprise transistors, for example, bipolar transistors or unipolar transistors such as field effect transistors, in particular MOS transistors.

In a preferred embodiment of the invention, the valve means are configured and operated as switches. That is, each valve is either in an “on” or conducting state, or in an “off” or nonconducting state, and a transition time between these two states is negligible with respect to the overall operation of the switch and the electroacoustic conversion means. The drive circuit in this case preferably is a class D amplifier, that is, an amplifier in which either a positive or a negative supply voltage or a zero voltage is supplied to the terminals of the electroacoustic conversion means, and in which an analog acoustical output signal is generated by pulse modulation of the voltage at said terminals.

In a preferred embodiment of the invention, a polarity independent valve or switch comprises two parallel transistors of complementary type. The two transistors are controlled by drive signals that are inverted with respect to each other. In a preferred embodiment of the invention, the two transistors are implemented as a complementary MOS circuit.

Other complementary arrangements of transistors are possible, that is, arrangements in which the characteristics of the two transistors complement one another. Control signals for the individual transistors may be adapted by inverting one of them within the valve or switch means itself. Alternatively, a drive circuit may provide inverted and non-inverted drive signals and provide both to the valve or switch. In another preferred embodiment of the invention, a “make before break” functionality is implemented by the control of the different switches: That is, a switch is configured to break (open) a first set of contacts before engaging (closing) some other new contacts. This prevents the momentary connection of the old and new signal paths.

Depending on the polarity of the battery with respect to the power supply terminals, one of the two transistors alternates between a partly conducting and a non-conducting state, and the other one synchronously alternates between a conducting and a non-conducting state, according to the drive signal.

In a further preferred embodiment of the invention, there is more than one rectifier circuit arranged for powering the primary function means. For example, a first rectifier circuit is configured to power an analog section of the primary function means, and a second rectifier circuit is configured to power a digital section of the primary function means. By having several rectifier circuits, interference between two or more separately powered sections is reduced. Such an arrangement of multiple rectifiers may be used together with the polarity-independent switching means as described above, but also alone, i.e. without them.

The method for operating an electronic battery-powered hearing instrument, wherein the drive circuit is electrically connected to the first power supply terminal and to the second power supply terminal, and the electrical valve means are polarity-independent, comprises the steps of
providing primary function means with power from the battery via a first power supply terminal and a second power supply terminal, and via a rectifier circuit for providing a positive supply voltage and a negative supply voltage regardless of the polarity of the battery relative to the first and second power supply terminal,
providing, by means of the primary function means, at least one drive signal to a drive circuit for driving an electroacoustic conversion means by controlling electrical valve means,
driving the electroacoustic conversion means regardless of the polarity of the battery relative to the first and second power supply terminal.

This results in controlling, by means of the electrical valve means, a current through the electroacoustic conversion means without incurring significant voltage drops and power losses elsewhere than in the electrical valve means.

Further preferred embodiments are evident from the dependent patent claims. Features of the method claims may be combined with features of the device claims and vice versa.

### BRIEF DESCRIPTION OF THE DRAWINGS

The subject matter of the invention will be explained in more detail in the following text with reference to preferred exemplary embodiments which are illustrated in the attached schematical drawings, in which:

FIG. 1 shows a block diagram of a hearing instrument according to the state of the art;

FIG. 2 shows a block diagram of the inventive hearing instrument; and

FIG. 3 shows an internal structure of polarity-independent electric valve means.

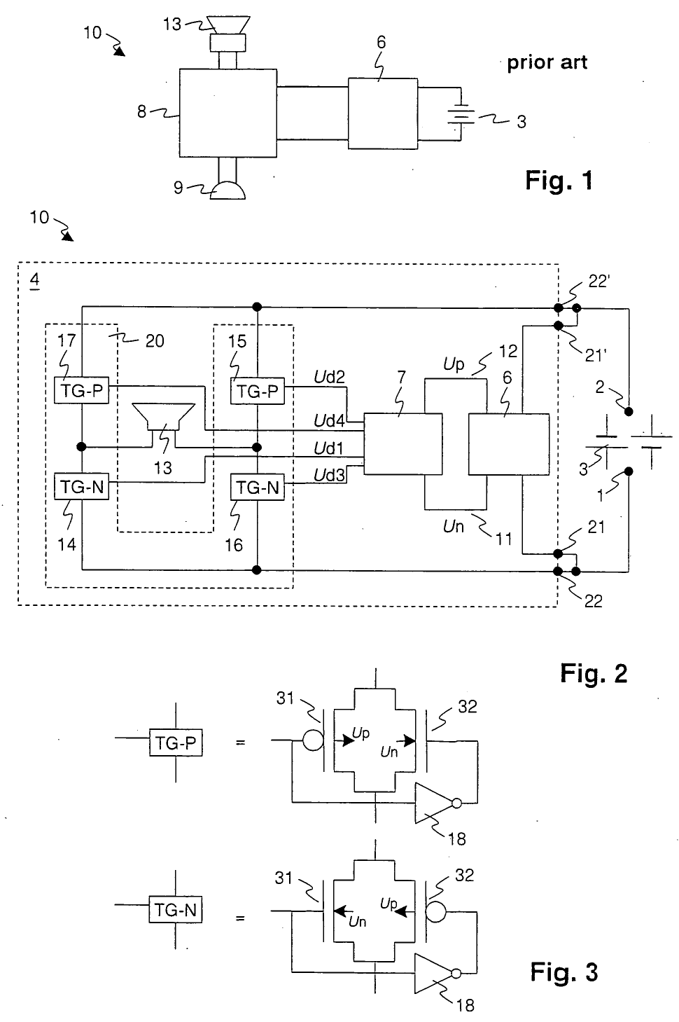

The reference symbols used in the drawings, and their meanings, are listed in summary form in the list of reference symbols. In principle, identical parts are provided with the same reference symbols in the figures.

### DETAILED DESCRIPTION OF PREFERRED EMBODIMENTS

FIG. 2 schematically shows a block diagram of a hearing aid 10 according to the invention. The hearing instrument 10 comprises a first power supply terminal 1 and a second power supply terminal 2 arranged to contact a battery 3 which may be inserted either way around. The first power supply terminal 1 and second power supply terminal 2 are electrically connected to power a rectifier circuit 6 which, regardless of the polarity of the battery 3, produces a negative supply voltage Un at a negative supply line 11 and a positive supply voltage Up at a positive supply line 12. The negative supply line 11 and positive supply line 12 power a primary function means 7 which comprises e.g. analog and/or digital signal processing means according to the functions of the hearing instrument 10. The signal processing means take as an input an audio signal from an input device—not shown in the figures—such as a microphone, telephone coil, radio frequency (RF) receiver etc. The signal processing means generate an output signal represented by one or more drive voltages Ud1, Ud2, Ud3, Ud4 driving an output amplifier or drive circuit 20.

The drive circuit 20 is connected to an electroacoustic conversion means 13 such as a loudspeaker. The circuit shown is also referred to as an H-bridge. The speaker preferably is an electrodynamic speaker, but may also be based on other principles.

The drive circuit 20 is electrically connected to the first power supply terminal 1 and to the second power supply terminal 2, with minimal resistance and without any further circuit elements of significant impedance, in particular without further electronic switching means located in the connections between the drive circuit 20 and the first power supply terminal 1 and the second power supply terminal 2, respectively.

The drive voltages Ud1, Ud2, Ud3, Ud4 are arranged to control polarity-independent electric valves 14, 15, 16, 17 of the drive circuit 20. The electrical valve means 14, 15, 16, 17 are polarity-independent, that is, they are able to operate regardless of the polarity of the voltage applied to their power terminals, i.e. the terminals carrying the current that is controlled.

Depending on the internal nature of the valve means 14, 15, 16, 17, the drive voltages Ud1, Ud2, Ud3, Ud4 maybe identical or maybe inverted for some of the valve means 14, 15, 16, 17 by one or more corresponding inverters inside the primary function means 7. There may be more than one drive signal per switch or valve. There may also be differences, e.g. small shifts of edges, in the timing of the otherwise identical control signals, in order to improve the signal quality of the output signals driving the speaker 13.

In a preferred embodiment of the invention, the electrical valve means 14, 15, 16, 17 are polarity-independent switches, in particular transmission gates, labeled TG-P and TG-N. With the valves being switches, and in the configuration of FIG. 2, the drive circuit 20 forms a class D amplifier.

The transmission gates 14, 15, 16, 17 are arranged to be switched such that they form a series configuration with the speaker 13. In particular, the drive circuit 20 is configured to establish, in accordance with the drive signal Ud,
either a current path connecting the first power supply terminal 1 via a first electrical valve means 14, the speaker 13 and a second electrical valve means 15 to the second power supply terminal 2,
or a current path connecting the first power supply terminal 1 via a third electrical valve means 16, the speaker 13 and a fourth electrical valve means 17 to the second power supply terminal 2.

Furthermore, the drive circuit 20 may also be configured to establish a short circuit current path for shorting the speaker 13 via the power supply terminals 1 or 2. This can be done for instance by connecting the first power supply terminal 1 via the switch 14, the speaker 13 and the switch 16 back to the first power supply terminal 1, or by connecting the second power supply terminal 2 via the switch 15, the speaker 13 and the switch 17 back to the second power supply terminal 2. In such a configuration, energy stored in the coil of the speaker 13 is dissipated.

Thus,
the first transmission gate 14 is electrically arranged between a first terminal of the speaker 13 and the first power supply terminal 1,
the second transmission gate 15 is electrically arranged between a second terminal of the speaker 13 and the second power supply terminal 2,
the third transmission gate 16 is electrically arranged between the second terminal of the speaker 13 and the first power supply terminal 1, and
the fourth transmission gate 17 is electrically arranged between the first terminal of the speaker 13 and the second power supply terminal 2.

As a result, the drive circuit 20 is configured to establish, during operation, a series circuit leading from the first power supply terminal 1 to the second power supply terminal 2. Said series circuit comprises the speaker 13 and no more than two electrical valve means 14, 15, 16, 17, that is, no further valve means or transistors or switching elements. Thus, there occurs no corresponding voltage drop comparable to the voltage drop in the electrical valve means 14, 15, 16, 17, and losses in the switches or valves are reduced accordingly.

In a further preferred embodiment of the invention, the drive circuit 20 and the primary function means 7 are arranged on an electronic circuit assembly 4 comprising
a first set of connectors 21,21′ for powering the primary function means 7 from the power supply terminals 1, 2 and
a second set of connectors 22,22′ for powering the drive circuit 20 from the power supply terminals 1, 2.

As a result, resistance of the amplifier circuits leading from the battery 3 to the electroacoustic conversion means 13 is further reduced. Furthermore, the supply noise, from a voltage drop caused by the current through the speaker and affecting the rectifier circuit 6 and the primary function means 7 can be further reduced.

FIG. 3 schematically shows an internal structure of the transmission gates. Each of the transmission gates 14, 15, 16, 17 comprises a pair of complementary MOS transistors 31, 32. Depending on the polarity of the MOS transistors, the transmission gates are labeled as TG-N or TG-P, respectively. The transistors forming a pair are driven by gate signals inverted with respect to each other by means of an inverter 18. The well or substrate connections of the transistors are made to the rectified supply voltages, i.e. to the positive supply voltage Up (for PMOS transistors) and the negative supply voltage Un (for NMOS transistors).

With such transmission gates, the first and fourth transmission gate 14, 17 are preferably controlled by the same drive voltage Ud1=Ud4, and the second and third transmission gate 15, 16 are preferably controlled by the same drive voltage Ud2=Ud3, which is inverted with respect to Ud1=Ud4 during operation of the speaker 13. For turning off a current flow through the speaker 13 and the battery, for example all drive voltages are set to the same value, i.e. Ud1=Ud2=Ud3=Ud4.

When the polarity of the battery 3 is inverted, the signal processing in the primary function means 7 can work as before, without having to be aware of the polarity of the inserted battery, and the polarity of the speaker signal is inverted. This corresponds to a 180° phase shift and is not perceptible to the user. However, in another embodiment, this is compensated by detecting the polarity and adapting the drive signals accordingly.

While the invention has been described in present preferred embodiments of the invention, it is distinctly understood that the invention is not limited thereto, but may be otherwise variously embodied and practiced within the scope of the claims.

Although the features and advantages of the invention are explained in terms of hearing instruments, they may be applied in an analogous fashion to arbitrary other devices in which the objects according to the invention arise.

### LIST OF DESIGNATIONS

1 first power supply terminal
2 second power supply terminal
3 battery
4 electronic circuit assembly (hybrid)
6 rectifier circuit
7 primary function means
8 amplifier
9 microphone
10 hearing instrument
11 negative supply line
12 positive supply line
13 electroacoustic conversion means, speaker
14 first transmission gate
15 second transmission gate
16 third transmission gate
17 fourth transmission gate
18 inverter
20 drive circuit
21, 21′ first set of connectors
22, 22′ second set of connectors
31 first transistor
32 second transistor
Un negative supply voltage
Up positive supply voltage
Ud drive voltage

What is claimed is:

1. An electronic battery-powered hearing instrument comprising
a first power supply terminal and a second power supply terminal arranged to contact a battery,
at least one rectifier circuit for providing a positive supply voltage and a negative supply voltage regardless of a polarity of the battery relative to the first and second power supply terminal,
primary function means arranged to provide at least one drive signal to a drive circuit for driving an electroacoustic conversion means, by controlling electrical valve means,
wherein the drive circuit is electrically connected to the first power supply terminal and to the second power supply terminal and in that the electrical valve means are polarity-independent.

2. The hearing instrument according to claim 1, wherein the drive circuit is configured to establish, during operation, a series circuit leading from the first power supply terminal to the second power supply terminal, said series circuit comprising the electroacoustic conversion means and no more than two electrical valve means.

3. The hearing instrument according to claim 2, wherein the drive circuit is configured to establish, in accordance with the drive signal,
a current path connecting the first power supply terminal via a first electrical valve means, the electroacoustic conversion means and a second electrical valve means to the second power supply terminal,
or a current path connecting the first power supply terminal via a third electrical valve means, the electroacoustic conversion means and a fourth electrical valve means to the second power supply terminal.

4. The hearing instrument according to claim 3, wherein the drive circuit is a class D amplifier and the electrical valve means are CMOS transmission gates.

5. The hearing instrument according to claim 4, wherein the CMOS transmission gates comprise individual PMOS and NMOS transistors, and the substrate connections of said transistors are connected to the positive supply voltage and the negative supply voltage, respectively.

6. The hearing instrument according to one of the preceding claims, wherein each of the polarity-independent electrical valve means comprises a pair of complementary transistors.

7. The hearing instrument according to one of claims 1 through 5, wherein the drive circuit and the primary function means are arranged on an electronic circuit assembly comprising a first set of connectors for powering the primary function means from the power supply terminals and a second set of connectors for powering the drive circuit from the power supply terminals.

8. The hearing instrument according to claim 6, wherein the drive circuit and the primary function means are arranged on an electronic circuit assembly comprising a first set of connectors for powering the primary function means from the power supply terminals and a second set of connectors for powering the drive circuit from the power supply terminals.

9. The hearing instrument according to one of claims 1 through 5, comprising a first rectifier circuit configured to power a first section of the primary function means, and a second rectifier circuit configured to power a second section of the primary function means.

10. The hearing instrument according to claim 6, comprising a first rectifier circuit configured to power a first section of the primary function means, and a second rectifier circuit configured to power a second section of the primary function means.

11. A method for operating an electronic battery-powered hearing instrument, comprising the steps of
providing primary function means with power from the battery via a first power supply terminal and a second power supply terminal, and via at least one rectifier circuit for providing a positive supply voltage and a negative supply voltage regardless of the polarity of the battery relative to the first and second power supply terminal,
providing, by means of the primary function means, at least one drive signal to a drive circuit for driving an electroacoustic conversion means by controlling electrical valve means,
wherein the drive circuit is electrically connected to the first power supply terminal and to the second power supply terminal, in that the electrical valve means are polarity-independent, and in that the method comprises the step of driving the electroacoustic conversion means regardless of the polarity of the battery relative to the first and second power supply terminal.

12. The method according to claim 11, comprising the step of the drive circuit establishing a series circuit leading from the first power supply terminal to the second power supply terminal, said series circuit comprising the electroacoustic conversion means and no more than two electrical valve means.

13. The method according to claim 12, comprising the step of the drive circuit establishing, in accordance with the drive signal,
a current path connecting the first power supply terminal via a first electrical valve means, the electroacoustic conversion means and a second electrical valve means to the second power supply terminal,
or a current path connecting the first power supply terminal via a third electrical valve means, the electroacoustic conversion means and a fourth electrical valve means to the second power supply terminal.
